(19) United States
(12) Patent Application Publication
(10) Pub. No.: US 2010/0227182 A1
(43) Pub. Date: Sep. 9, 2010

(54) THERMOPLASTIC MOLDED VEHICLE LIGHT BEZEL

(75) Inventors: Brett Collin Dobrick, Wilmington, DE (US); Benjamin Weaver Messmore, Wilmington, DE (US); Hiroyuki Sumi, Tochigi-Ken (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/715,634

(22) Filed: Mar. 2, 2010

Related U.S. Application Data
(60) Provisional application No. 61/156,941, filed on Mar. 3, 2009.

(51) Int. Cl. B32B 15/09; C08K 5/098

(52) U.S. Cl. 428/458; 524/394

(57) ABSTRACT

Disclosed is a thermoplastic molded vehicle light bezel including a polyester molding resin comprising a thermoplastic polyester selected from the group consisting of poly(butylene terephthalate) homopolymer, poly(butylene terephthalate) copolymer, poly(trimethylene terephthalate) homopolymer, poly(trimethylene terephthalate) copolymer and blends thereof, and sodium montanate.

### CROSS REFERENCE TO RELATED APPLICATIONS

This application claims the benefit of U.S. Provisional Application No. 61/156,941, filed Mar. 3, 2009, which is incorporated herein by reference in its entirety.

### FIELD OF INVENTION

This invention is directed to thermoplastic molded vehicle light bezel.

### BACKGROUND OF INVENTION

Molded articles comprising thermoplastic polymers are useful in the manufacture of optical reflectors, for example in automotive headlight extensions, bezels and reflectors, for indoor illumination, for vehicle interior illumination and the like. For instance, published patent application WO 2008/066988 discloses a composition comprising thermoplastic poly(butylene terephthalate) (PBT) and poly(ethylene terephthalate) (PET) useful in the manufacture of lighting articles.

Poly(trimethylene terephthalate) (PTT) polyester, is another an attractive material for use in engineering resin applications as it provides physical properties and processing characteristics similar to other polyester resins such as PBT. PTT has a higher equilibrium cyclic oligomer concentration, typically about 2.5% by weight based on the resin weight, when compared to similar polyesters such as PET or PBT, that typically have 1.4-1.8% by weight of cyclic oligomer. The most abundant cyclic oligomer of PTT is the cyclic dimer. When PTT resin molded parts are subjected to higher than normal temperature conditions (80° C. to 160° C.) the cyclic dimer of PTT is observed to bloom to the surface of the molded part, resulting in an undesirable cosmetic defect. A related problem for polymer compositions, in particular polyester compositions and polymer compositions having a polyester component, is the release of low molecular weight components when heated, referred to as “outgassing”. This can be a particular problem in polymer parts that are often or even constantly subjected to high temperatures, such as a bezel, a housing for a lamp or a reflector for a lamp, all of which are heated by the lamp.

Outgassing can be classified as “volatile” or “condensable”. Volatile outgassing consists of lower molecular weight gaseous components, such as flavorants or odorants. Condensable outgassing refers to components that are driven off under heat or ambient conditions, and which condense on relatively cooler surfaces, forming an oily, waxy or solid deposit, which may be perceived as a haze or film. This effect is also known as ‘fogging’.

Condensable outgassing is a particular problem in components which must have a high degree of surface perfection, and in optical components where a film or deposit may be easily perceived and good transmission of light is important. For example, conventional bezels for headlamps are often made of thermoplastics, such as polyester, for instance PBT. The automotive headlamp assembly is an enclosed system containing metalized reflectors, light components and electrical connectors, headlamp adjusters etc., enclosed within a housing and a transparent lens cover which is usually produced from polycarbonate. Within this assembly, the bezel is a cover which is fitted around the light bulbs and reflectors to hide the internal workings. The bezel is an aesthetic/visible part, and is designed to look good. A high degree of surface perfection is required.

On prolonged heat exposure, due to the heat of the light bulb, or ambient conditions, such as strong sunlight, condensable outgassing from a conventional polyester bezel can condense on the transparent headlamp cover, leading to a visible film or deposit on the lens that is not only unattractive but which causes a decrease in light transmission.

Furthermore, condensable outgassing species can lead to defects on directly metalized polymer surfaces. For example, microcracking of the metal coating on directly metalized thermoplastic bezels can sometimes occur on heating. Condensable outgassing species may migrate through these cracks onto the metalized surface, leading to cloudiness or loss of reflectance (“haze”) of the high gloss metalized surface.

WO 2004/106405 discloses a method for reducing condensable outgassing in polybutylene terephthalate (PBT) compositions comprising using PBT compositions having a “cyclic dimer” content of less than 0.3 wt %.

A need remains for polyester compositions with reduced levels of condensable outgassing.

### SUMMARY OF INVENTION

One aspect of the invention is a thermoplastic molded vehicle light bezel comprising a polyester molding resin comprising:
a) a thermoplastic polyester selected from the group consisting of poly(butylene terephthalate) homopolymer, poly(butylene terephthalate) copolymer, poly(trimethylene terephthalate) homopolymer, poly(trimethylene terephthalate) copolymer, and blends thereof, having an intrinsic viscosity of at least 0.7 dL/g; and
b) 0.01 to 0.5 weight percent of sodium montanate
   wherein said weight percent is based on the total weight of said polyester molding resin.

Another aspect of the invention is a polyester molding resin that exhibits significantly less condensable outgassing as compared to molding resins having conventional lubricants,

### DETAILED DESCRIPTION

One aspect of the invention is a thermoplastic molded vehicle light bezel comprising a polyester molding resin that has reduced condensable outgassing.

Herein “copolymer” refers to polymers comprising copolymerized units resulting from copolymerization of two or more comonomers. “Dipolymer” refers to polymers consisting essentially of two comonomer-derived units and “terpolymer” means a copolymer consisting essentially of three comonomer-derived units.

Useful in the invention are thermoplastic polyesters selected from the group consisting of poly(butylene terephthalate) homopolymer, poly(butylene terephthalate) copolymer, poly(trimethylene terephthalate) homopolymer, poly(trimethylene terephthalate) copolymer, and blends thereof.

A poly(butylene terephthalate) homopolymer means any polymer consisting essentially of repeat units of butylene terephthalate. A poly(butylene terephthalate) homopolymer is substantially derived from the polymerization of 1,4-butanediol with terephthalic acid, or alternatively, derived from the ester-forming equivalents thereof (e.g., any reactants which may be polymerized to ultimately provide a polymer of poly(butylene terephthalate). A most preferred molding resin comprises poly(butylene terephthalate) homopolymer.

A “poly(butylene terephthalate) copolymer” means any polymer comprising at least about 80 mole percent butylene terephthalate and the remainder of the polymer being derived from monomers other than terephthalic acid and 1,4-butanediol, or their ester forming equivalents. Ester-forming equivalents include diesters such as dimethylterephthalate. Examples of poly(butylene terephthalate) copolymers include copolyesters synthesized from 3 or more reactants, each having two ester forming groups. For example, a poly(butylene terephthalate) copolymer may be prepared by reacting 1,4-butanediol, terephthalic acid, and one or more comonomers selected from linear, cyclic, and branched aliphatic dicarboxylic acids having 4 to 12 carbon atoms such as butanedioic acid, pentanedioic acid, hexanedioic acid, azelaic acid, sebacic acid, dodecanedioic acid, 1,4-cyclohexane-dicarboxylic acid, or ester-forming equivalents thereof; aromatic dicarboxylic acids other than terephthalic acid having 8 to 12 carbon atoms such as phthalic acid, isophthalic acid or 2,6-naphthalenedicarboxylic acid; linear, cyclic, and branched aliphatic dials other than 1,4-butanediol having 2 to 8 carbon atoms such as ethanediol, 1,2-propanediol, 1,3-propanediol, hexamethylene glycol, 3-methyl-1,5-pentanediol, 2,2-dimethyl-1,3-propanediol, 2-methyl-1,3-propanediol, cyclohexane dimethanol or 1,4-cyclohexanediol; and aliphatic and aromatic ether glycols having 4 to 10 carbon atoms such as hydroquinone bis(2-hydroxyethyl)ether. Alternatively, a poly(butylene terephthalate) copolymer may be prepared from a poly(ethylene ether) glycol having a molecular weight below about 460, such as diethylene ether glycol, methoxypolyalkylene glycol, diethylene glycol, and polyethylene glycol. The comonomer may be present in the copolymer at a level of about 0.5 to about 15 mol %, and may be present at a level of up to about 30 mol %.

The poly(butylene terephthalate) copolymer may comprise other comonomers and such comonomers may be copolymerized into the copolymer chain in minor amounts, e.g., up to about 10 mol %, or up to about 5 mol %. Examples of such other comonomers include functional comonomers such as 5-sodium sulfoisophthalate, which can be in an amount of about 0.2 to about 5 mol %. Very small amounts, about 5 mol % or less, or about 2 mol % or less, of trimellitic anhydride, trimellitic acid, pyromellitic dianhydride (pmda), pentaerythritol or other acids or diols that have more than two reactive sites may be incorporated as branching agents to increase the melt viscosity and improve the rheology for coextrusion in multilayer structures.

Preferred polybutylene terephthalate) copolymer contain at least about 85 mol %, at least about 90 mol %, at least about 95 mol %, or at least about 98 mol %, of copolymerized units of butylene terephthalate.

A “poly(trimethylene terephthalate) homopolymer” means any polymer consisting essentially of repeat units of trimethylene terephthalate. A poly(trimethylene terephthalate) homopolymer is substantially derived from the polymerization of 1,3-propanediol with terephthalic acid, or alternatively, derived from the ester-forming equivalents thereof (e.g., any reactants which may be polymerized to ultimately provide a polymer of poly(trimethylene terephthalate). Another most preferred molding resin comprises poly(trimethylene terephthalate) homopolymer.

A “poly(trimethylene terephthalate) copolymer” means any polymer comprising (or derived from) at least about 80 mole percent trimethylene terephthalate and the remainder of the polymer being derived from monomers other than terephthalic acid and 1,3-propanediol, or their ester forming equivalents. Examples of poly(trimethylene terephthalate) copolymers include copolyesters synthesized from 3 or more reactants, each having two ester forming groups. For example, a poly(trimethylene terephthalate) copolymer may be prepared by reacting 1,3-propanediol, terephthalic acid, and one or more dicarboxylic acids and/or diols, as disclosed above.

Preferred poly(trimethylene terephthalate) copolymers contain at least about 85 mol %, at least about 90 mol %, at least about 95 mol %, or at least about 98 mol %, of copolymerized units of trimethylene terephthalate.

One embodiment is a thermoplastic molded vehicle light bezel wherein the thermoplastic polyester is a poly(trimethylene terephthalate) homopolymer or copolymer having poly(trimethylene terephthalate) repeat units and end groups, said poly(trimethylene terephthalate resin having a cyclic dimer content of less than or equal to 1.1 wt %, as determined with nuclear magnetic resonance analysis, based on the weight of said poly(trimethylene terephthalate) repeat units and said cyclic dimer; and an intrinsic viscosity of 0.9 to about 2.0 dL/g, and preferably 0.9 to 1.5 dL/g.

For a preferred PTT molding resin used herein, the cyclic dimer is of the following formula (I)

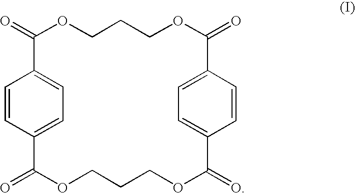

For determination of cyclic dimer content, NMR analysis is used herein. The analysis directly measures the content of all terephthalate groups in the polymer repeat units including the terepthalate present in any end groups, and in a separate and distinct region the terepthalate groups of the cyclic dimer. The peak attributed to the cyclic dimer is at about 7.7 ppm, distinct from the PTT terephthalate repeat units at 8.1 ppm.

Poly(trimethylene terephthalate) resin having a cyclic dimer content of less than or equal to 1.1 wt %, is available by solid state polymerization of PTT comprising:

providing an initial PTT resin composition comprising poly(trimethylene terephthalate) repeat units, in the form of a plurality of pellets having a pellet size of 3.0-4.0 g/100 pellets, said initial PTT resin composition having an initial cyclic dimer content and one or more a condensation catalyst; said initial poly(trimethylene terephthalate) resin composition having an intrinsic viscosity of 0.50 to 0.89 dL/g;

heating and agitating the plurality of resin pellets to a condensation temperature for a condensation time to provide said high viscosity PTT resin having poly(trimethylene terephthalate) repeat units and having a low cyclic dimer content of less than or equal to 1.1 wt % as determined with nuclear magnetic resonance analysis and an intrinsic viscosity in the range of 0.9 to 2.0 dL/g; wherein the cyclic dimer content is based on the weight of said poly(trimethylene terephthalate) repeat units and said cyclic dimer.

The initial PTT resin has one or more a condensation catalyst, preferably about 25 to about 200 ppm based on the weight of said initial PTT resin composition. A preferred catalyst is titanium (IV) butoxide.

The heating and agitating the plurality of resin pellets to a condensation temperature can be done in a rotary dryer, fluidized bed, or fluidized column reactor in the range of 180° C. and 215° C., and under a reduced pressure of about 0.1 to about 10 mm Hg.

An alternative PTT solid state polymerization process is disclosed in U.S. Pat. No. 7,332,561.

The thermoplastic composition useful in the invention further includes about 0.01 to about 0.5 wt % of sodium montanate, and more preferably about 0.05 to 0.4 wt %. Suitable for the invention is Licomont® NAV101 sodium montanate available from Clariant Corp. The thermoplastic polyester composition may also include additives such as fillers, flow modifiers, heat stabilizers, antioxidants, dyes, pigments, UV stabilizer, and the like, provided that they don't negatively impact the physical properties, surface properties or outgassing of the molded article.

The compositions useful in the present invention are in the form of a melt-mixed blend, wherein the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method. The component materials may be mixed to homogeneity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until homogeneous. The sequence of mixing in the manufacture of the thermoplastic composition may be such that individual components may be melted in one shot, or the filler and/or other components may be fed from a side feeder, and the like, as will be understood by those skilled in the art.

The thermoplastic compositions are formed into molded vehicle light bezels using methods known to those skilled in the art, such as, for example, injection molding.

The vehicle light bezels can be metalized to provide a metal layer on a portion of, or over the entire area of the molded articles, by any means known in the art. Preferably the metal layer is provided by vapor deposition or sputtering deposition on at least one surface of the molded article. Preferred metals for the metal layer are selected from the group consisting of aluminum, chrome, and stainless steel. Aluminum is a more preferred metal layer. Preferably the metal layer is a film of metal having a thickness of less than 1 micron and, preferably, about 500 Angstroms to about 1000 Angstroms, and more preferably about 600 to about 800 Angstroms.

Various embodiments of the invention are molded vehicle light bezels including metalized bezels, for vehicles including those selected from the group consisting of tail light bezel, head light bezel, directional light bezel and interior light bezel.

### Materials

Poly(butylene terephthalate) (PBT) refers to Crastin® 6003, manufactured by E.I. du Pont de Nemours and Co., Wilmington, Del.
C-Black refers to Wilson 15-BK-98 25 wt % carbon black in PBT carrier.
Licowax® OP lubricant is a partially saponified ester of montanic acid available from Clariant Corp. (Charlotte, N.C. 28205, USA).
Na montanate refers to Licomont® NAV101 sodium montanate available from Clariant Corp. (Charlotte, N.C. 28205, USA).

### Methods

### Sample Preparation and Physical Testing

All of the components shown in Table 1 were combined and fed to the rear of a ZSK 40 mm twin screw extruder and melt mixed using at a melt temperature of about 270° C. to yield a resin composition. Exiting the extruder, the composition was passed through a die to form strands that were cooled and solidified in a quench tank and subsequently chopped to form pellets.

The resultant compositions were molded into 4 mm ISO all-purpose bars. The test pieces were used to measure mechanical properties on samples at 23° C. and dry as molded. The following test procedures were used and the results are given in Table 1:

Tensile strength and elongation at break: ISO 527-1/2

Flexural modulus and strength: ISO 178

### Mold Shrinkage

Mold shrinkage is assessed by measuring the precise dimensions of a 100 mm×100 mm×2 mm mold and comparing these to those of a molded article derived from the mold in the flow direction and transverse to the flow direction.

### Fogging Test for Condensible Outgassing

The Fogging test apparatus consisted of a glass cup (15 mm Inner diameter×132 mm length) mounted in a metal heat block to a depth of 67 mm; and the glass cup covered with a polycarbonate compact disc, with the recording side (surface coated with hardcoat and anti-static coating) facing the interior of the cup. The polyester molding resin sample (5 g, particle size about 3-5 mm×3-5 mm×2 mm; cut from a 2 mm thick molded plaque) was place in the glass cup, the compact disc mounted on the cup and sealed with tape. The cup was heated to 170° C. for 2 hours. The compact disc was removed and the surface of the compact disc was then observed to determine the extent of fogging. The compact disc was observed again after 20 minutes sitting in air. The results are listed in Table 1.

### Intrinsic Viscosity

The intrinsic viscosity (IV) of the PTT resin was determined using viscosity measured with a Viscotek Forced Flow Viscometer Y-501 (Viscotek Corporation, Houston, Tex.) for the polymers dissolved in 50/50 weight trifluoroacetic acid/methylene chloride at a 0.4 grams/dL concentration at 19° C. following an automated method based on ASTM D 5225-92. The measured viscosity was then correlated with standard viscosities in 60/40 wt % phenol/1,1,2,2-tetrachloroethane as determined by ASTM D 4603-96 to arrive at the reported intrinsic values.

### Determination of Cyclic Dimer Content by NMR

4-6 pellets of PTT were melt pressed at 260° C. and melted for 5 minutes and subsequently pressed to 10,000 lbs of pressure to create a thin film (0.14 mm thick) to increase the surface area of the polymer for easy dissolution. The pressed film of polymer (15 mg) was added to CDCl₃/TFA-d (5:1, 1 mL) mixture and dissolved. The solution was transferred to a 5 mm NMR tube and analyzed within one hour of sample preparation. 64 scans were run at 30° C. with a 16 second delay time on a Varian INOVA 500 MHz NMR with a proton/fluorine/carbon probe. The obtained spectrum was integrated at the terephthalate region (8.1 ppm) and the cyclic dimer region (7.65 ppm). The weight percent of cyclic dimer is calculated by dividing the integration value of the cyclic dimer region by the sum of the integration values of the cyclic dimer region and the terephthalate region multiplied by 100.

### EXAMPLES

Table 1 lists components used in Example 1, having sodium montanate as a lubricant; versus Comparative Example C-1, having a conventional partially saponified montanate ester mixture. The physical properties of the Example 1 and Comparative Example 1 are similar. However there is a significant and unexpected difference in the fogging or outgassing properties of the Examples. Example 1 shows very little fogging; whereas the conventional lubricant shows significant fogging; that does not evaporate upon standing at room temperature.

TABLE 1

| Example | 1 | C-1 |
|---|---|---|
| PBT | 98.65 | 98.65 |
| C-Black | 1.15 | 1.15 |
| Licowax ® OP | | 0.20 |
| Na montanate | 0.20 | |
| Total % | 100 | 100 |
| Tensile Strength (Mpa) | 58 | 58 |
| Flexual Strength (Mpa) | 90 | 85 |
| Flexual Modulus (GPa) | 2.5 | 2.5 |
| Mold Shrinkage | | |
| Flow direction % | 1.9 | 1.8 |
| Transverse direction % | 1.8 | 1.8 |
| Fogging | | |
| 170° C./2 h | Very slight | Severe fogging |
| after 20 min at RT | No visible blemish | Severe fogging |

What is claimed is:

1. A thermoplastic molded vehicle light bezel comprising a polyester molding resin comprising:
a) a thermoplastic polyester selected from the group consisting of poly(butylene terephthalate) homopolymer, poly(butylene terephthalate) copolymer, poly(trimethylene terephthalate) homopolymer, poly(trimethylene terephthalate) copolymer, and blends thereof, having an intrinsic viscosity of at least 0.7 dL/g; and
b) 0.01 to 0.5 weight percent of sodium montanate
wherein said weight percent is based on the total weight of said polyester molding resin.

2. The thermoplastic molded vehicle light bezel of claim 1 wherein said polyester is poly(butylene terephthalate) homopolymer.

3. The thermoplastic molded vehicle light bezel of claim 1 wherein said thermoplastic polyester is poly(trimethylene terephthalate) homopolymer or copolymer resin having poly(trimethylene terephthalate) repeat units and end groups, said poly(trimethylene terephthalate) resin having a cyclic dimer content of less than or equal to 1.1 wt %, as determined with nuclear magnetic resonance analysis, based on the weight of said poly(trimethylene terephthalate repeat units and said cyclic dimer; and an intrinsic viscosity of 0.9 to about 2.0 dL/g.

4. The thermoplastic molded vehicle light bezel of claim 1 wherein said polyester is a blend of poly(butylene terephthalate) and poly(trimethylene terephthalate).

5. The thermoplastic molded vehicle light bezel of claim 1 wherein said polyester is poly(butylene terephthalate).

6. The thermoplastic molded vehicle light bezel of claim 1 that is selected from the group consisting of tail light bezel, head light bezel, interior light automotive light bezel.

7. The thermoplastic molded vehicle light bezel of claim 1 further comprising at least one surface having a metal layer.

8. The thermoplastic molded vehicle light bezel of claim 7 wherein the metal layer is selected from the group consisting of aluminum, chrome, and stainless steel.
